(19) United States
(12) Patent Application Publication
(10) Pub. No.: US 2023/0394453 A1
(43) Pub. Date: Dec. 7, 2023

(54) ENERGY METERING METHOD, APPARATUS, DEVICE AND SYSTEM, AND STORAGE MEDIUM

(71) Applicant: Goldcard Smart Group Co., Ltd., Zhejiang (CN)

(72) Inventors: Yuanming DING, Zhejiang (CN); Ying YAN, Zhejiang (CN); Tongliang LIU, Zhejiang (CN)

(73) Assignee: Goldcard Smart Group Co., Ltd., Zhejiang (CN)

(21) Appl. No.: 18/249,108

(22) PCT Filed: Nov. 2, 2021
(86) PCT No.: PCT/CN2021/128230

§ 371 Date: Apr. 14, 2023

(30) Foreign Application Priority Data
Nov. 13, 2020 (CN) 202011269765.7

(51) Int. Cl. G06Q 20/14; G06Q 50/06

(52) U.S. Cl. CPC G06Q 20/145; G06Q 50/06

(57) ABSTRACT

The present application provides an energy metering method, apparatus, device and system, and a storage medium. The energy metering method includes: obtaining a volume consumption of natural gas of a user within a metering period; determining heat values of various gas sources published in each publishing period within the metering period; determining a heat value of natural gas used by the user according to a gas source supply structure corresponding to the user and the heat values of various gas sources published in each publishing period; determining an energy consumption of natural gas of the user within the metering period according to the volume consumption of natural gas of the user within the metering period and the heat value of the natural gas used by the user.

### CROSS-REFERENCE TO RELATED APPLICATION

This application is a national stage of International Application No. PCT/CN2021/128230, filed on Nov. 2, 2021, which claims priority to Chinese Patent Application No. 202011269765.7, filed on Nov. 13, 2020. Both of the aforementioned applications are hereby incorporated by reference in their entireties.

### TECHNICAL FIELD

The present application relates to the field of data processing technology and, in particular, to an energy metering method, apparatus, device and system, and a storage medium.

### BACKGROUND

Natural gas is one of the important energy sources in daily life. The traditional natural gas billing method is based on the volume consumption. In fact, there are many kinds of natural gas sources, which have different compositions, and different heat values. This billing method based on volume is unfair to users.

Therefore, relevant departments have also formulated relevant management measures to adjust the billing method. They have clarified the requirements for establishing a natural gas energy metering and billing system and the requirements for natural gas wholesale links such as gates and stations to use the heat quantity as the basis for trade settlement.

However, at present, settlement based on volume is still used for end users. Different settlement methods between upstream and downstream may cause gas transmission difference, increase the management difficulty of the gas company, and at the same time, it is unfair to the end gas users.

### SUMMARY

The present application provides an energy metering method, apparatus, device and system, and a storage medium, which realize energy metering of natural gas used at a user terminal to reduce the natural gas transmission difference.

In a first aspect, the present application provides an energy metering method, including:
obtaining a volume consumption of natural gas of a user within a metering period;
determining heat values of various gas sources published in each publishing period within the metering period;
determining a heat value of natural gas used by the user according to a gas source supply structure corresponding to the user and the heat values of various gas sources published in each publishing period, the gas source supply structure being used to indicate a type, a quantity, and a gas supply mode of a gas source of the natural gas used by the user;
determining an energy consumption of natural gas of the user within the metering period according to the volume consumption of natural gas of the user within the metering period and the heat value of the natural gas used by the user.

In an embodiment, the method further includes:
dividing users in a target region into a plurality of billing regions according to a gas source supply structure corresponding to each of the users in the target region, gas source supply structures of each of the billing regions being the same;
where the determining the heat value of the natural gas used by the user according to the gas source supply structure corresponding to the user and the heat values of various gas sources published in each publishing period includes:
for each of the billing regions, determining a heat value of natural gas corresponding to the billing region according to a gas source supply structure corresponding to the billing region and the heat values of various gas sources published in each publishing period;
determining a billing region to which the user belongs according to the gas source supply structure corresponding to the user;
determining the heat value of the natural gas used by the user according to a heat value of natural gas of the billing region to which the user belongs.

In an embodiment, for each of the billing regions, the determining the heat value of the natural gas corresponding to the billing region according to the gas source supply structure corresponding to the billing region and the heat values of various gas sources published in each publishing period includes:
for each of the billing regions, if there is a unique gas source in the billing region directly supplying natural gas to respective users, determining the heat value of the natural gas corresponding to the billing region according to a heat value of the unique gas source published in each publishing period.

In an embodiment, for each of the billing regions, the determining the heat value of the natural gas corresponding to the billing region according to the gas source supply structure corresponding to the billing region and the heat values of various gas sources published in each publishing period includes:
for each of the billing regions, if there are at least two gas sources in the billing region directly and alternately supplying natural gas to respective users, determining the heat value of the natural gas corresponding to the billing region according to respective gas supply time of the at least two gas sources and heat values of the at least two gas sources published in each publishing period.

In an embodiment, for each of the billing regions, the determining the heat value of the natural gas corresponding to the billing region according to the gas source supply structure corresponding to the billing region and the heat values of various gas sources published in each publishing period includes:
for each of the billing regions, if there are at least two gas sources in the billing region jointly supplying natural gas to respective users, obtaining a delivery volume of the at least two gas sources within the metering period;
determining the heat value of the natural gas corresponding to the billing region according to the delivery volume of the at least two gas sources within the metering period and heat values of the at least two gas sources published in each publishing period.

In an embodiment, for each of the billing regions, the determining the heat value of the natural gas corresponding to the billing region according to the gas source supply structure corresponding to the billing region and the heat values of various gas sources published in each publishing period includes:
for each of the billing regions, if there are at least two gas sources in the billing region, with a part of gas from the at least two gas sources jointly supplying natural gas to respective users and another part of gas from the at least two gas sources separately and individually supplying natural gas to other billing regions, then obtaining a volume consumption of each of the other billing regions supplied by the another part of gas from the at least two gas sources;
determining the heat value of the natural gas corresponding to the billing region according to the volume consumption of each of the other billing regions supplied by the another part of gas from the at least two gas sources and heat values of the at least two gas sources published in each publishing period.

In an embodiment, before determining the heat value of the natural gas corresponding to the billing region, the method further includes:
determining whether there exists an industrial user in the billing region;
if there exists the industrial user in the billing region, obtaining an energy consumption of natural gas of the industrial user within the metering period;
for each of the billing regions, the determining the heat value of the natural gas corresponding to the billing region according to the gas source supply structure corresponding to the billing region and the heat values of various gas sources published in each publishing period includes:
for each of the billing regions, if there exists the industrial user in the billing region, determining the heat value of the natural gas corresponding to the billing region according to the energy consumption of the natural gas of the industrial user within the metering period and the heat values of various gas sources published in each publishing period.

In an embodiment, where the obtaining the energy consumption of the natural gas of the industrial user within the metering period includes:
obtaining a daily average volume consumption and a daily average heat value of the natural gas of the industrial user within the metering period;
determining the energy consumption of the natural gas of the industrial user within the metering period according to the daily average volume consumption and the daily average heat value of the natural gas within the metering period.

In a second aspect, the present application provides an energy metering apparatus, including:
an obtaining module, configured to obtain a volume consumption of natural gas of a user within a metering period;
a determining module, configured to determine heat values of various gas sources published in each publishing period within the metering period;
a processing module, configured to determine a heat value of natural gas used by the user according to a gas source supply structure corresponding to the user and the heat values of various gas sources published in each publishing period, the gas source supply structure being used to indicate a type, a quantity, and a gas supply mode of a gas source of the natural gas used by the user; determine an energy consumption of natural gas of the user within the metering period according to the volume consumption of natural gas of the user within the metering period and the heat value of the natural gas used by the user.

In a third aspect, the present application provides an energy metering device, including: a memory, configured to store program instructions; a processor, configured to call and execute the program instructions stored in the memory to execute the methods according to the first aspect.

In a fourth aspect, the present application provides a computer-readable storage medium, where the storage medium stores a computer program, when the computer program is executed by a processor, the method according to any of the above-mentioned methods is implemented.

In a fifth aspect, the present application provides a program product, which includes a computer program stored in a readable storage medium from which a processor of an electronic device can read the computer program, and the processor executes the computer program to cause the electronic device to implement the method according to the first aspect.

In a sixth aspect, the present application provides an energy metering system, including: a gas metering apparatus at a user side and a heat value detecting apparatus at a gas source side, which are respectively connected with the energy metering apparatus;
the gas metering apparatus is configured to meter a volume consumption of natural gas at a user terminal;
the heat value detection device is configured to detect a heat value of the gas source;
the energy metering apparatus is configured to execute the energy metering method according to the first aspect.

The present application provides an energy metering method, apparatus, device and system, and a storage medium. The energy metering method includes: obtaining a volume consumption of natural gas of a user within a metering period; determining heat values of various gas sources published in each publishing period within the metering period; determining a heat value of natural gas used by the user according to a gas source supply structure corresponding to the user and the heat values of various gas sources published in each publishing period, the gas source supply structure being used to indicate a type, a quantity, and a gas supply mode of a gas source of the natural gas used by the user; determining an energy consumption of natural gas of the user within the metering period according to the volume consumption of natural gas of the user within the metering period and the heat value of the natural gas used by the user. According to the gas source supply structure corresponding to the user, a composition mode of the gas source corresponding to the natural gas used by the user can be determined, and then the heat value of the natural gas used by the user can be determined according to the heat value of each gas source, and then the energy consumption can be obtained according to the volume consumption of the natural gas of the user. In this way, the energy metering of the natural gas used by the user terminal can be realized, realizing the unification of upstream and downstream billing methods, thus reducing the natural gas transmission difference.

### BRIEF DESCRIPTION OF DRAWINGS

In order to explain the technical solutions in the present application or in the prior art more clearly, drawings needed in the description of embodiments or in the prior art will be briefly introduced below. Obviously, the drawings in the following description are some embodiments of the present application. For ordinary skilled in the field, other drawings can be obtained according to these drawings without paying creative labor.

FIG. 1 is a schematic diagram of an application scenario provided by the present application.

FIG. 2 is a flow chart of an energy metering method provided by an embodiment of the present application.

FIG. 3 is a schematic flow chart of a server side obtaining relevant data of a volume consumption of natural gas from a user side according to an embodiment of the present application.

FIG. 4 is a schematic diagram of a gas source supply structure provided by an embodiment of the present application.

FIG. 5 is a schematic diagram of another gas source supply structure provided by an embodiment of the present application.

FIG. 6 is a schematic diagram of another gas source supply structure provided by an embodiment of the present application.

FIG. 7 is a schematic diagram of another gas source supply structure provided by an embodiment of the present application.

FIG. 8 is a schematic structural diagram of an energy metering apparatus provided by an embodiment of the present application.

FIG. 9 is a schematic structural diagram of an energy metering device provided by an embodiment of the present application.

FIG. 10 is a schematic structural diagram of an energy metering system provided by an embodiment of the present application.

### DESCRIPTION OF EMBODIMENTS

In order to make the purpose, technical solutions and advantages of the present application more clear, the technical solutions in the present application will be described clearly and completely with the drawings in the present application. Obviously, the described embodiments are part of the embodiments of the present application, but not all of them. Based on the embodiments in the present application, all other embodiments obtained by ordinary skilled in the field without creative work belong to the protection scope of the present application.

There are generally three metering methods of natural gas: volume metering, mass metering and energy metering. Among them, mass metering is generally used for the metering of compressed natural gas. Most countries in America, Europe, Middle East and Asia adopt energy metering, while at present, the volume metering is mainly adopted in our country. However, considering the need of being consistent with foreign countries in regard to international natural gas trade, and in order to realize fair trade, a transformation from volume metering to energy metering is gradually promoted in our country. The change is first proposed in the upstream wholesale link, and the change in the billing method of the wholesale link will definitely push the unfairness in pricing to the user terminal.

However, there are many difficulties in realizing the change of gas billing method at the user terminal, among which the accurate metering of heat value of the gas is a big difficulty. However, it is more difficult to add the function of metering the heat value of the gas to the user terminal, so the gas meter used by the end user still calculates the price by metering the gas volume. Even if meters that can realize energy metering are developed, it will take a long period for large quantities of meters to be produced and replaced. In the meantime, the settlement method of end users also needs to be improved.

Therefore, the present application provides an energy metering method, apparatus and device, and a storage medium suitable for natural gas. The existing meter is still used to collect and report a volume consumption of the user terminal normally while the process of energy metering is set on the server side, where a heat value of natural gas used by each user is calculated according to a corresponding gas source supply structure, and then an energy consumption is finally determined, combined with the volume consumption reported by the gas meter, so as to realize energy metering.

FIG. 1 is a schematic diagram of an application scenario provided by the present application. As shown in FIG. 1, in a certain region, only one gas source (gas source 1 in FIG. 1) directly provides natural gas to users in the region. A gas source heat value detecting apparatus connected to the gas source side detects a heat value of natural gas output by the gas source and uploads it to the server according to an uploading rule; a terminal gas metering apparatus connected to a gas pipeline at the user side detects a volume consumption of natural gas of the user and uploads it to the server according to an uploading rule. The heat value of the natural gas at the gas source side is the heat value of the natural gas at the user side, so the server can calculate the energy consumption of the natural gas of the user according to the heat value of the natural gas at the gas source side and the volume consumption of the natural gas of the user. As an example, the scenario in FIG. 1 simply provides one implementation of gas supply modes, and more implementations will be described below.

Reference can be made to the following embodiments for the specific implementations of the present application.

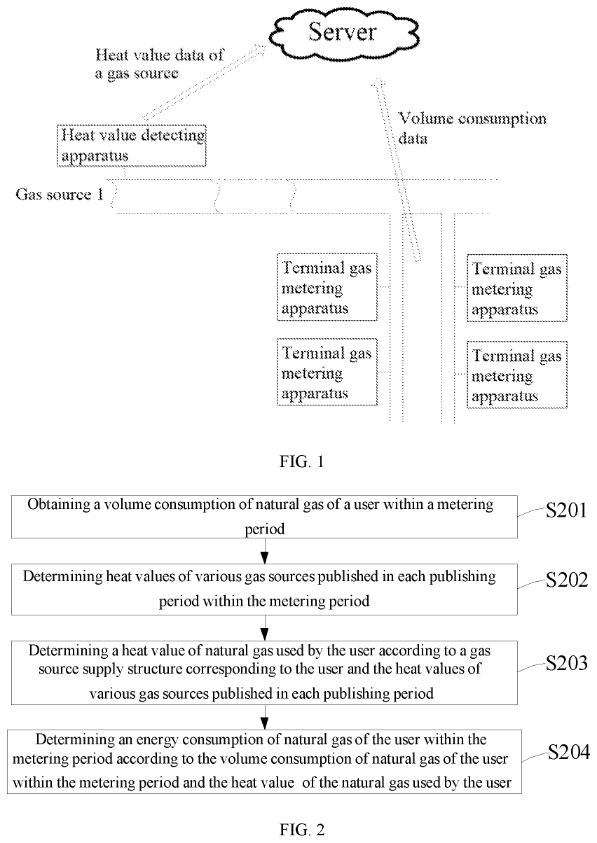

FIG. 2 is a flow chart of an energy metering method provided by an embodiment of the present application. The execution body of the method in the present embodiment may be a terminal device such as a server. As shown in FIG. 2, the method of the present embodiment may include:
S201, obtaining a volume consumption of natural gas of a user within a metering period.

In the present application, “metering period” refers to a period for calculating the energy consumption of the natural gas used by the user, which can be one day, one week, one month, etc. The length of the period and the specific starting time point and ending time point can be determined according to an actual scenario or adjusted according to an actual situation.

The volume consumption data obtained by the execution body (i.e., the server) of the method provided by the present embodiment can be collected by the gas volume collecting apparatus at the user side and sent directly or indirectly. After obtaining the relevant data, the server can parse out the data and store.

The gas volume collecting apparatus at the user side can be a civil gas meter, an industrial and commercial gas meter, an industrial and commercial flow meter, etc. The civil meter can be gas meters such as an ordinary rubber film meter, an IC card meter, a micro-power wireless meter, an Internet of Things meter, an NB-IoT meter, etc.; the industrial and commercial gas meter can be a G6-G40 industrial and commercial gas meter; the industrial and commercial flow meter can be a DN25-DN200 industrial and commercial flow meter.

The gas volume collecting apparatus meters the gas consumption of the corresponding user based on its own principle, and uploads it to the server. The uploaded information may include data such as a device number corresponding to the apparatus, a volume consumption of natural gas in an uploading period or an accumulated volume consumption of natural gas.

Generally, a meter with a communication function can upload data automatically, with a fixed or an adjustable uploading period; a gas meter without a communication function generally does not have the function of automatic uploading, which requires manual assistance in uploading, and also has a period of the manual assisted uploading. Therefore, the concept of “uploading period” is introduced here. Similar to the above-mentioned “metering period”, the length of the period can be one day, one week, one month, etc., and the length of the period and the specific starting time point and ending time point can be determined according to an actual scenario or adjusted according to an actual situation.

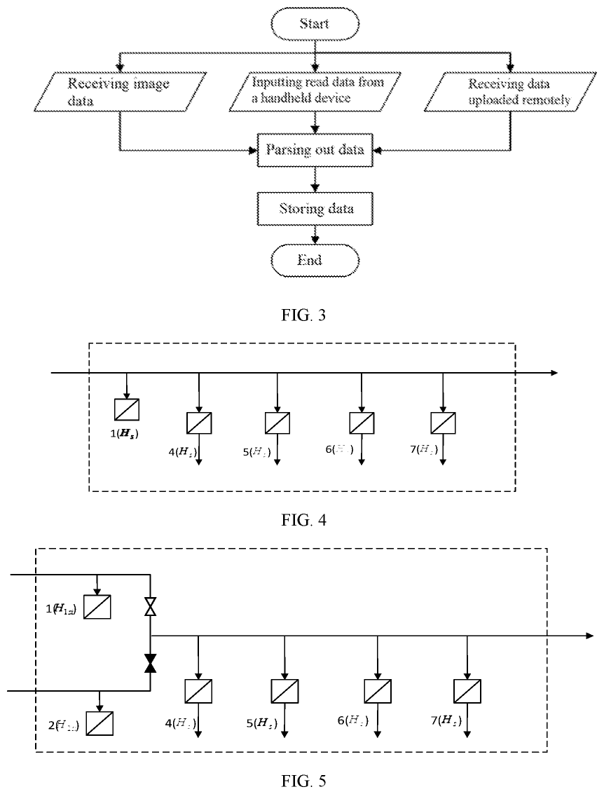

FIG. 3 is a schematic flow chart of a server side obtaining relevant data of a volume consumption of natural gas from a user side according to an embodiment of the present application.

For a meter with a communication function, the server receives data uploaded remotely and wirelessly according to a data uploading period of the meter, parses out effective data thereof and stores it.

For gas meters without communication function, such as a base meter and an IC card meter, the volume consumption data can be transmitted to the server regularly by manual shooting uploading. Specifically, cameras, smart phones and other devices with an image acquisition function can be used to perform image acquisition operations such as taking pictures of meters, recording videos and the like, and the collected images or video data can be sent to the server through the terminal device that can communicate with the server, so that the server can perform image processing on the images or video data to obtain the user information (meter information) contained therein. For example, uploading the image data to the server through, such as a terminal application, an applet (mini-program) of the smart phone, and the like. The server receives a front photo of the gas meter uploaded by the applet or terminal application from a designated interface, and parses a number of the gas meter and the volume consumption in the photo and stores them.

For Internet of Things meters, NB-Iot (Narrow Band-Internet of Things) meters, micro-power wireless meters for centralized reading and so on, the volume consumption data of natural gas can be collected by a special centralized meter reading device and then imported into the server. The server imports the meter read data from the handheld meter reading device from a designated data import interface, parses out valid data thereof and stores it.

It should be noted that the metering period and the uploading period may be the same or different. A unified metering period may be adopted for all meters, or the metering period can be determined according to the uploading period.

For example, for the base meter, the IC card meter and the meter with centralized meter reading by handheld device, the uploading period can be determined as the metering period, and can be set as one quarter or two months.

For another example, the metering period of the Internet of Things meter, NB-Iot meter, etc. can be set to one or more days.

S202, determining heat values of various gas sources published in each publishing period within the metering period.

The heat value data of the gas source obtained by the execution body (i.e., the server) of the method provided by the present embodiment can be collected and sent by the gas source heat value detecting apparatus at the gas source side. The server can store the relevant data after obtaining it.

Specifically, the gas source heat value detecting apparatus can be a detecting apparatus of an official supervision center, which detects the heat value data of the gas source and publishes it regularly. Generally, the published heat value is an average heat value in a publishing period, or data of multiple heat values obtained from multiple times of detection in the publishing period.

In the present application, the “publishing period” refers to a period for publishing a heat value of natural gas of the gas source, which can be one hour or one day. The length of the publishing period and the specific starting time point and ending time point can be determined according to an actual scenario.

In addition, the publishing periods of different gas sources may be different.

S203, determining a heat value of natural gas used by the user according to a gas source supply structure corresponding to the user and the heat values of various gas sources published in each publishing period.

Where the gas source supply structure is used to indicate a type, a quantity, and a gas supply mode of a gas source of the natural gas used by the user. For example, which gas source supplies natural gas to a user; if multiple gas sources supply gas, the gas supply mode is a joint supply mode or a separate interval supply mode, etc.

Understandably, different gas sources with different components correspond to different heat values. Different gas sources, or the same gas source with different gas supply modes will affect the composition of natural gas used by the user, so the corresponding heat values thereof will be different.

Once the gas source supply structure corresponding to the user is determined, a composition of the natural gas used by the user or a proportion of various components of gas sources can be determined roughly, then in combination with the heat values of various gas sources, the heat value of the natural gas used by the user can be determined.

An updating period of the heat value of the natural gas used by the user can be consistent with the publishing period of the heat values of gas sources, that is, after each publishing period, this step is executed once when the heat values of gas sources are obtained to determine the heat value of the natural gas used by the user; the updating period of the heat value of the natural gas used by the user can also be inconsistent with the publishing period, for example, the heat value of the natural gas used by the user is calculated once after multiple publishing periods.

S204, determining an energy consumption of the natural gas of the user within the metering period according to the volume consumption of the natural gas of the user within the metering period and the heat value of the natural gas used by the user.

The energy of natural gas has a stable corresponding relationship with volume and heat value, which can be expressed by a formula as follows:

E=H×Q (1)

In the formula (1), E represents the energy, H represents the heat value and Q represents the volume. Other formulas in the present application will also use these expressions to indicate corresponding variables, and at the same time use superscript or subscript to indicate metering conditions of the corresponding variables. As mentioned above, the metering period, updating period, uploading period, etc. correspond to the above three variables respectively, that is, each variable has a time condition for metering (the formula (1) does not reflect the time, but actually the variables are deemed to be within the same time range by default).

The publishing period, updating period, metering period and uploading period may be consistent or inconsistent, and corresponding actual algorithm formulas need to consider the time factor.

The energy metering method provided by the present embodiment includes: obtaining a volume consumption of natural gas of a user within a metering period; determining heat values of various gas sources published in each publishing period within the metering period; determining a heat value of natural gas used by the user according to a gas source supply structure corresponding to the user and the heat values of various gas sources published in each publishing period, the gas source supply structure being used to indicate a type, a quantity, and a gas supply mode of a gas source of the natural gas used by the user; determining an energy consumption of natural gas of the user within the metering period according to the volume consumption of natural gas of the user within the metering period and the heat value of the natural gas used by the user. According to the gas source supply structure corresponding to the user, a composition mode of the gas source corresponding to the natural gas used by the user can be determined, and then the heat value of the natural gas used by the user can be determined according to the heat value of each gas source, and then the energy consumption can be obtained according to the volume consumption of the natural gas of the user. In this way, the energy metering of the natural gas used by the user terminal can be realized, realizing the unification of upstream and downstream billing methods, thus reducing the natural gas transmission difference.

According to the above analysis, it can be determined that for users corresponding to the same gas source supply structure, the heat values of natural gas used by them are the same. Based on this feature, users can be classified according to gas source supply structures, and users with the same gas source supply structure can be classified into the same category to form an abstract billing region. The heat value of natural gas used is calculated and stored uniformly for each billing region, so that the heat value can be used for energy metering of users in the billing region. This can simplify the calculation in the server and improve the processing efficiency.

Specifically, users in the target region can be divided into multiple billing regions according to the gas source supply structure corresponding to each user in the target region. Where gas source supply structures of each of the billing regions are the same.

Accordingly, in the above step S203, the heat value of the natural gas used by the user is determined according to the gas source supply structure corresponding to the user and the heat values of various gas sources published in each publishing period, and the step can specifically include: for each of the billing regions, determining a heat value of natural gas corresponding to the billing region according to a gas source supply structure corresponding to the billing region and the heat values of various gas sources published in each publishing period and the heat values of various gas sources published in each publishing period; determining a billing region to which the user belongs according to the gas source supply structure corresponding to the user; determining the heat value of the natural gas used by the user according to a heat value of natural gas of the billing region to which the user belongs.

The “target region” mentioned in the present application may refer to a region where users managed by the server are located. Specifically, it can be a geographical region, such as a city; or a region under the management of a gas company; or a region supplied by a certain gas source.

In order to facilitate management, after dividing the billing regions, for the volume collecting device at the user side in each billing region, an identification of the billing region to which the volume collecting device belongs can be added. For example, a reference number is set for each billing region, and this reference number is stored in association with the identity of the collecting device at the user side.

When it is necessary to meter the energy of a certain user, the billing region can be determined according to the reference number associated with its identity. The heat value data of the billing region can be directly obtained, which can be used to meter the energy of the user.

According to different gas source supply structures, calculating methods of heat values of natural gas used by respective users or calculating methods of heat values of respective billing regions are also different.

It can be understood that gas source supply structures of several regions may be the same, that is to say, the billing region may also be embodied as a geographical gathering region.

In another implementation, regarding the above steps S203 and S204, the metering of the energy consumption of the natural gas of the user within the metering period can also be realized in another way, which can specifically include: dividing users in a target region into a plurality of billing regions according to a gas source supply structure corresponding to each of the users in the target region; for each of the billing regions, obtaining a total volume consumption of natural gas in the billing region within the metering period; determining a billing region to which the user belongs according to the gas source supply structure corresponding to the user; determining the energy consumption of the natural gas of the user within the metering period according to the total volume consumption of natural gas in the billing region to which the user belongs within the metering period, the heat value of the gas source, a volume consumption of natural gas of each user in the billing region within the metering period and the volume consumption of the natural gas of the user within the metering period.

That is, the heat value of the natural gas in the billing region is not calculated separately, but the total energy consumption of natural gas in the billing region within the metering period is calculated according to the total volume consumption of natural gas in the billing region to which the user belongs within the metering period and the heat value of the gas source, and the energy consumption of the natural gas of the user within the metering period is determined by using the proportion of the volume consumption of natural gas in the billing region of the user as the proportion of the energy consumption of natural gas in the billing region of the user.

Specifically, the total volume consumption of natural gas in the billing region can be metered by setting a flow metering apparatus at a gas inlet of the billing region.

In some embodiments, for each of the billing regions, the determining the heat value of the natural gas corresponding to the billing region according to the gas source supply structure corresponding to the billing region and the heat values of various gas sources published in each publishing period includes: for each of the billing regions, if there is a unique gas source in the billing region directly supplying natural gas to respective users, determining the heat value of the natural gas corresponding to the billing region according to a heat value of the unique gas source published in each publishing period.

FIG. 4 is a schematic diagram of a gas source supply structure provided by an embodiment of the present application. As shown in FIG. 4, there is one gas supply source, which is fixed and has a stable heat value, and directly and continuously supplies gas to the user side. Under this gas source supply structure, the gas composition of the gas source side is always consistent with the gas composition of the user side. Therefore, the heat value of the gas source is the heat value of the natural gas used at the user side. Users with the same gas source supply structure can be assigned to the same billing region. Assuming that there are n publishing periods in the updating period, that is, the updating period is n times the length of the publishing period, the formula for calculating the heat value of the natural gas corresponding to this billing region is as follows:

$${H}_{s} = \frac{{\sum }_{i = 1}^{n} {H}_{si}}{n} \qquad ( 2 )$$

In formula (2), Hₛ represents the heat value of the natural gas corresponding to the billing region updated in an updating period, and Hₛᵢ represents the heat value of the gas source published in an i-th publishing period within the updating period.

For each of the billing regions, the determining the heat value of the natural gas corresponding to the billing region according to the gas source supply structure corresponding to the billing region and the heat values of various gas sources published in each publishing period includes: for each of the billing regions, if there are at least two gas sources in the billing region directly and alternately supplying natural gas to respective users, determining the heat value of the natural gas corresponding to the billing region according to respective gas supply time of the at least two gas sources and heat values of the at least two gas sources published in each publishing period.

FIG. 5 is a schematic diagram of another gas source supply structure provided by an embodiment of the present application. As shown in FIG. 5, there are two gas supply sources with the same gas flow direction, and one gas source is used to supply gas to the user side separately at different time periods, and a switch between the gas sources is conducted for different time periods. Under this gas source supply structure, the gas composition of the gas source supplied by the gas source side is always consistent with the gas composition of the user side in each time period. Therefore, the heat value of the natural gas used at the user side is related to the heat value of each gas source at the gas source side and the gas supply time. Users with the same gas source supply structure can be assigned to the same billing region. Assuming that there are n publishing periods of gas source 1 and m publishing periods of gas source 2 in the updating period, that is, the updating period is n times the length of the publishing period of gas source 1 and m times the length of the publishing period of gas source 2, the formula for calculating the heat value of the natural gas corresponding to this billing region is as follows:

$${H}_{s} = \frac{\frac{{Σ}_{i = 1}^{n} {H}_{1 si}}{n} + \frac{{Σ}_{j = 1}^{m} {H}_{2 si}}{m}}{2} \qquad ( 3 )$$

In formula (3), m and n are both numbers greater than 1, Hₛ represents the heat value of the natural gas corresponding to the billing region updated in an updating period, H₁ₛᵢ represents the heat value of gas source 1 published in an i-th publishing period within the updating period, and H₂ₛⱼ represents the heat value of gas source 2 published in a j-th publishing period within the updating period.

If both m and n are numbers smaller than 1, the updating period is shorter than the publishing period, and it can be determined, according to the specific length of the period, the updating period falls within the gas supply period of which gas source. If the updating period falls within the gas supply period of gas source 1, the heat value of the natural gas corresponding to the billing region in the updating period is the heat value of gas source 1 in this period.

Alternatively, when the uploading period is short, or usage time of natural gas of a user can be uploaded, the heat value corresponding to the time when the gas is used can be intercepted more accurately according to the usage time of the natural gas and the supply time of each gas source.

In other embodiments, for each of the billing regions, the determining the heat value of the natural gas corresponding to the billing region according to the gas source supply structure corresponding to the billing region and the heat values of various gas sources published in each publishing period includes: for each of the billing regions, if there are at least two gas sources in the billing region, with a part of gas from the at least two gas sources jointly supplying natural gas to respective users and another part of gas from the at least two gas sources separately and individually supplying natural gas to other billing regions, then obtaining a volume consumption of each of the other billing regions supplied by the another part of gas from the at least two gas sources; determining the heat value of the natural gas corresponding to the billing region according to the volume consumption of each of the other billing regions supplied by the another part of gas from the at least two gas sources and heat values of the at least two gas sources published in each publishing period.

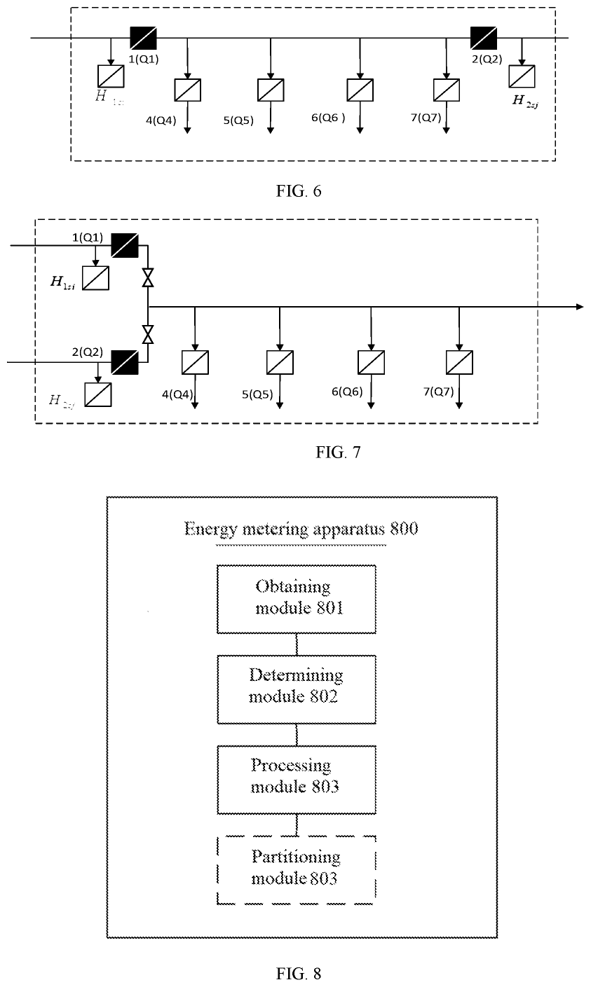

FIG. 6 is a schematic diagram of another gas source supply structure provided by an embodiment of the present application. As shown in FIG. 6, there are two gas supply sources 1 and 2 respectively, and gases with different mass and from different numbers of gas supply resources are transmitted to billing regions (4, 5, 6, 7) and gathered at the entrance of the billing region 6 to jointly supply gas to the billing region 6. The gas source structures of billing regions 4, 5 and 7 are similar to those in FIG. 3. In billing region 6, it is equivalent that two gas sources supply gas to the user side simultaneously, but the mass of the gas supplied is not necessarily the same. Assuming that there are n publishing periods of gas source 1 and m publishing periods of gas source 2 in the updating period, that is, the updating period is n times the length of the publishing period of gas source 1 and m times the length of the publishing period of gas source 2, the formula for calculating the heat value of the natural gas corresponding to the billing region 6 is as follows:

$${H}_{s} = E / {Q}_{6} \qquad ( 4 )$$

$$E = \frac{{\sum }_{i = 0}^{n} {H}_{1 si}}{n} \times {Q}_{61} + \frac{{\sum }_{j = 0}^{m} {H}_{2 sj}}{m} \times {Q}_{62} \qquad ( 5 )$$

$${Q}_{61} = {Q}_{1} - {Q}_{4} - {Q}_{5} \qquad ( 6 )$$

$${Q}_{62} = {Q}_{2} - {Q}_{7} \qquad ( 7 )$$

In formulas (4)-(7), m and n are both numbers greater than 1, H s represents the heat value of the natural gas corresponding to the billing region updated in an updating period, E represents the energy of natural gas flowing through billing region 6 in the updating period, Q₆ represents the volume of gas flowing through billing region 6 in the updating period, Q₆₁ represents the volume of gas input by gas source 1 to billing region 6, and Q₆₂ represents the volume of gas input by gas source 2 to billing region 6. Q₁ represents the volume of gas output by gas source 1 in an updating period and Q₂ represents the volume of gas output by gas source 2 in an updating period, Q₄ represents the volume of gas input by gas source 1 to billing region 4, Q₅ represents the volume of gas input by gas source 1 to billing region 5, and Q₇ represents the volume of gas input by gas source 2 to billing region 7, H₁ₛᵢ represents the heat value of gas source 1 published in an i-th publishing period in the updating period, H₂ₛⱼ represents the heat value of gas source 2 published in a j-th publishing period in the updating period.

Among them, Q₄, Q₅ and Q₇ can be obtained by flow meters set at the entrance of each billing region. Actually, Q₆ can also be obtained by a flow meter arranged at the entrance of the billing region 6. However, in this way, only the total flow can be obtained, and the proportion of gas in gas source 1 and gas in gas source 2 cannot be determined, thus leading to large error in the calculated heat value. The above method is utilized to calculate the energy of gas source 1 and the energy of gas source 2 separately and then determine the total energy, so that the heat value of natural gas is more accurate.

In other embodiments, for each of the billing regions, the determining the heat value of the natural gas corresponding to the billing region according to the gas source supply structure corresponding to the billing region and the heat values of various gas sources published in each publishing period includes: for each of the billing regions, if there are at least two gas sources in the billing region jointly supplying natural gas to respective users, obtaining a delivery volume of the at least two gas sources within the metering period; determining the heat value of the natural gas corresponding to the billing region according to the delivery volume of the at least two gas sources within the metering period and heat values of the at least two gas sources published in each publishing period.

The delivery volume of the gas source can be metered by the gas source volume collecting module arranged at the gas source side, and the volume data can be uploaded to the server according to a volume uploading period. The volume uploading period can be 1 hour, 1 day, and the like.

Specifically, a volume under a standard condition of a gas source can be determined based on working conditions metered by a medium pressure flow meter and a high pressure flow meter, a temperature in a gas pipeline collected by a temperature detecting apparatus and a pressure in the gas pipeline collected by a pressure detecting apparatus.

FIG. 7 is a schematic diagram of another gas source supply structure provided by an embodiment of the present application. As shown in FIG. 7, there are two gas supply sources, with the same gas flow direction, which jointly supply gas to the user side. Under this gas source supply structure, a component of a mixed gas composed of the two gas sources supplied by the gas source side is always consistent with a gas component of the user side. Users with the same gas source supply structure can be assigned to the same billing region. Assuming that there are n publishing periods of gas source 1 and m publishing periods of gas source 2 in the volume uploading period, that is, the volume uploading period is n times the length of the publishing period of gas source 1 and m times the length of the publishing period of gas source 2, the formula for calculating the heat value of the natural gas corresponding to this billing region is as follows:

$${H}_{s} = E / ( {Q}_{1} + {Q}_{2} ) \qquad ( 8 )$$

$$E = \frac{{\sum }_{i = 0}^{n} {H}_{1 si}}{n} \times {Q}_{1} + \frac{{\sum }_{j = 0}^{m} {H}_{2 sj}}{m} \times {Q}_{2} \qquad ( 9 )$$

In formulas (8)-(9), m and n are both numbers greater than 1, Hₛ represents the heat value of the natural gas corresponding to the billing region updated in an updating period, E represents the energy of natural gas flowing through the billing region in an updating period, H₁ₛᵢ represents the heat value of gas source 1 published in an i-th publishing period in the updating period, H₂ₛⱼ represents the heat value of gas source 2 published in a j-th publishing period in the updating period, Q₁ represents the volume of gas output by gas source 1 in an updating period, and Q₂ represents the volume of gas output by gas source 2 in an updating period.

Assuming that the volume uploading period of gas source 1 is the same as the publishing period, and the volume uploading period of gas source 2 is the same as the publishing period, and the lengths are shorter than the length of the metering period, the formula for calculating the heat value of the natural gas corresponding to this billing region is as follows:

Hₛ=E/(Q₁+Q₂) (10)

E=Σᵢ₌₀ⁿH₁ₛᵢ×Q₁ᵢ+Σⱼ₌₀^{m}H₂ₛⱼ×Q₂ⱼ (11)

Due to the characteristics of gas, its density is small and its fluidity is strong, the natural gas supplied to each user after mixture of natural gas from different gas sources may not be completely uniform. For ordinary household users, because the consumption of natural gas is small, when the above method is adopted directly, the average heat value of the billing region is used as the heat value of natural gas for a user, the error is small. However, there may be large industrial users (such as a power plant, a steel plant, etc.) in some billing regions. These large industrial users use a large amount of natural gas, which may have a great impact on the average heat value of the whole billing region, so they can be treated separately.

Correspondingly, before determining the heat value of the natural gas corresponding to the billing region, the method further includes: determining whether there exists an industrial user in the billing region; if there exists the industrial user in the billing region, obtaining an energy consumption of natural gas of the industrial user within the metering period; for each of the billing regions, the determining the heat value of the natural gas corresponding to the billing region according to the gas source supply structure corresponding to the billing region and the heat values of various gas sources published in each publishing period includes: for each of the billing regions, if there exists the industrial user in the billing region, determining the heat value of the natural gas corresponding to the billing region according to the energy consumption of the natural gas of the industrial user within the metering period and the heat values of various gas sources published in each publishing period.

Generally, an industrial user will use a heat value collecting device to analyze and detect the heat value and volume consumption of natural gas. Similar to ordinary users' meters, the detected heat value and volume consumption can be uploaded to the server. The server can determine the energy consumption of the natural gas of the industrial user within the metering period according to the industrial user's daily average volume consumption of natural gas and a heat value of natural gas, and then determine energy consumptions of natural gas of other ordinary users within the metering period and the heat value of natural gas in the billing region. Here, the heat value of natural gas in the billing region refers to the average heat value of natural gas used by ordinary users other than the industrial user.

Specifically, for the embodiment corresponding to FIG. 6, if there exists an industrial user in billing region 6 and the heat value collecting device is installed, the formula for calculating the heat value of the other ordinary users in billing region 6 is as follows:

$$E = \frac{{\sum }_{i = 0}^{n} {H}_{1 si}}{n} \times {Q}_{61} + \frac{{\sum }_{j = 0}^{m} {H}_{2 sj}}{m} \times {Q}_{62} - {\sum }_{k = 0}^{x} {H}_{k} \times {Q}_{k} \qquad ( 12 )$$

$${H}_{s} = E / ( {Q}_{6} - {\sum }_{k = 0}^{x} {Q}_{k} ) \qquad ( 13 )$$

In formulas (12)-(13), Qₖ represents the daily cumulative gas consumption of an industrial user k, and Hₖ represents the daily average heat value of the industrial user k.

For the embodiment corresponding to FIG. 7, if there exists an industrial user in the billing region and the heat value collecting device is installed, the method for calculating the heat value of the other users in the billing region is as follows:

$$E = \frac{{\sum }_{i = 0}^{n} {H}_{1 si}}{n} \times {Q}_{1} + \frac{{\sum }_{j = 0}^{m} {H}_{2 sj}}{m} \times {Q}_{2} - {\sum }_{k = 0}^{x} {H}_{k} \times {Q}_{k} \qquad ( 14 )$$

$${H}_{s} = E / ( {Q}_{6} - {\sum }_{k = 0}^{x} {Q}_{k} ) \qquad ( 15 )$$

In formulas (14)-(15), Qₖ represents the daily cumulative gas consumption of the industrial user k, and Hₖ represents the daily average heat value of the industrial user k.

Specifically, the above-mentioned obtaining the energy consumption of the natural gas of the industrial user within the metering period includes: obtaining a daily average volume consumption and a daily average heat value of the natural gas of the industrial user within the metering period; determining the energy consumption of the natural gas of the industrial user within the metering period according to the daily average volume consumption and the daily average heat value of the natural gas within the metering period.

The heat value collecting device installed by the industrial user can collect the daily average heat value and gas consumption of the industrial user to calculate the energy consumption of the industrial user. For a billing region using the mixed gas, assigned heat values of other meters in the billing region can be more accurate. For industrial users, such as a large steel plant and a power plant, etc., the installed heat value collecting device can be an online gas chromatography (GC) analyzer.

FIG. 8 is a schematic structural diagram of an energy metering apparatus provided by an embodiment of the present application. As shown in FIG. 8, the energy metering apparatus 800 provided by the present embodiment may include an obtaining module 801, a determining module 802, and a processing module 803.

The obtaining module 801 is configured to obtain a volume consumption of natural gas of a user within a metering period;
the determining module 802 is configured to determine heat values of various gas sources published in each publishing period within the metering period;
the processing module 803 is configured to determine a heat value of natural gas used by the user according to a gas source supply structure corresponding to the user and the heat values of various gas sources published in each publishing period, the gas source supply structure being used to indicate a type, a quantity, and a gas supply mode of a gas source of the natural gas used by the user; determine an energy consumption of natural gas of the user within the metering period according to the volume consumption of natural gas of the user within the metering period and the heat value of the natural gas used by the user.

In an embodiment, the apparatus 800 further includes a partitioning module 804, which is configured to divide users in a target region into a plurality of billing regions according to a gas source supply structure corresponding to each of the users in the target region, gas source supply structures of each of the billing regions being the same.

The processing module 803, when determining the heat value of the natural gas used by the user according to the gas source supply structure corresponding to the user and the heat values of various gas sources published in each publishing period, is specifically configured to:
for each of the billing regions, determine a heat value of natural gas corresponding to the billing region according to a gas source supply structure corresponding to the billing region and the heat values of various gas sources published in each publishing period;
determine a billing region to which the user belongs according to the gas source supply structure corresponding to the user;
determine the heat value of the natural gas used by the user according to a heat value of natural gas of the billing region to which the user belongs.

In an embodiment, for each of the billing regions, when determining the heat value of the natural gas corresponding to the billing region according to the gas source supply structure corresponding to the billing region and the heat values of various gas sources published in each publishing period, the processing module 803 is specifically configured to:
for each of the billing regions, if there is a unique gas source in the billing region directly supplying natural gas to respective users, determine the heat value of the natural gas corresponding to the billing region according to a heat value of the unique gas source published in each publishing period.

In an embodiment, for each of the billing regions, when determining the heat value of the natural gas corresponding to the billing region according to the gas source supply structure corresponding to the billing region and the heat values of various gas sources published in each publishing period, the processing module 803 is specifically configured to:
for each of the billing regions, if there are at least two gas sources in the billing region directly and alternately supplying natural gas to respective users, determine the heat value of the natural gas corresponding to the billing region according to respective gas supply time of the at least two gas sources and heat values of the at least two gas sources published in each publishing period.

In an embodiment, for each of the billing regions, when determining the heat value of the natural gas corresponding to the billing region according to the gas source supply structure corresponding to the billing region and the heat values of various gas sources published in each publishing period, the processing module 803 is specifically configured to:
for each of the billing regions, if there are at least two gas sources in the billing region jointly supplying natural gas to respective users, obtain a delivery volume of the at least two gas sources within the metering period
determine the heat value of the natural gas corresponding to the billing region according to the delivery volume of the at least two gas sources within the metering period and heat values of the at least two gas sources published in each publishing period

In an embodiment, for each of the billing regions, when determining the heat value of the natural gas corresponding to the billing region according to the gas source supply structure corresponding to the billing region and the heat values of various gas sources published in each publishing period, the processing module 803 is specifically configured to:
for each of the billing regions, if there are at least two gas sources in the billing region, with a part of gas from the at least two gas sources jointly supplying natural gas to respective users and another part of gas from the at least two gas sources separately and individually supplying natural gas to other billing regions, obtain a volume consumption of each of the other billing regions supplied by the another part of gas from the at least two gas sources;
determine the heat value of the natural gas corresponding to the billing region according to the volume consumption of each of the other billing regions supplied by the another part of gas from the at least two gas sources and heat values of the at least two gas sources published in each publishing period.

In an embodiment, the processing module 803, before determining the heat value of the natural gas corresponding to the billing region, is further configured to:
determine whether there exists an industrial user in the billing region;
if there exists the industrial user in the billing region, obtain an energy consumption of natural gas of the industrial user within the metering period; For each of the billing regions, when determining the heat value of the natural gas corresponding to the billing region according to the gas source supply structure corresponding to the billing region and the heat values of various gas sources published in each publishing period, the processing module 803 is specifically configured to:
for each of the billing regions, if there exists the industrial user in the billing region, determine the heat value of the natural gas corresponding to the billing region according to the energy consumption of the natural gas of the industrial user within the metering period and the heat values of various gas sources published in each publishing period.

In an embodiment, the processing module 803, when obtaining the energy consumption of the natural gas of the industrial user within the metering period, is specifically configured to:
obtain a daily average volume consumption and a daily average heat value of the natural gas of the industrial user within the metering period;
determine the energy consumption of the natural gas of the industrial user within the metering period according to the daily average volume consumption and the daily average heat value of the natural gas within the metering period.

The device provided in the present embodiment can be used to implement the energy metering method in the above embodiment, and achieve the same technical effect, so the details are not repeated here.

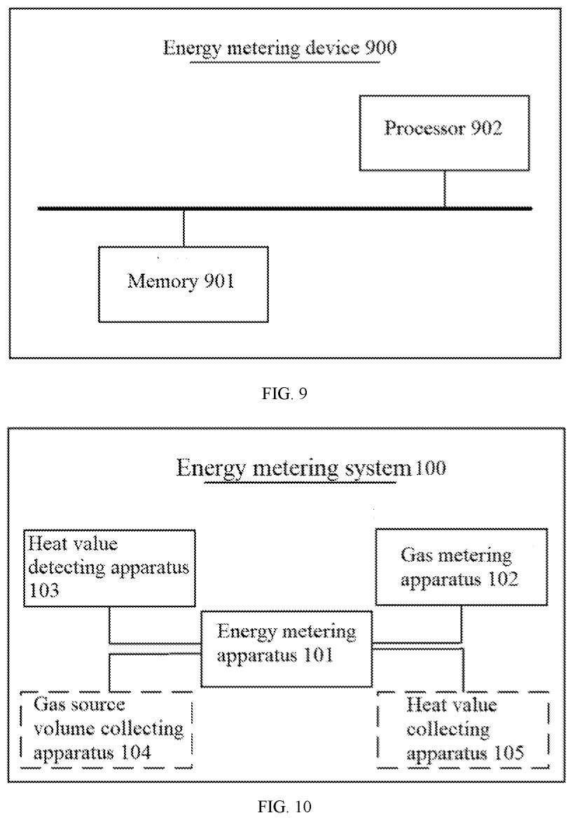

FIG. 9 is a schematic structural diagram of an energy metering device provided by an embodiment of the present application. As shown in FIG. 9, the energy metering device 900 of the present embodiment may include a memory 901 and a processor 902.

The memory 901 is configured to store program instructions.

The processor 902 is configured to call and execute the program instructions in the memory 901 to execute the above energy metering method.

The energy metering apparatus of the present embodiment can be used to execute the method of any of the above embodiments, and its implementation principle and technical effect are similar, which will not be repeated here.

The present application also provides a storage medium which stores a computer program, when the computer program is executed by a processor, the method according to any one of the above embodiments is implemented.

FIG. 10 is a schematic structural diagram of an energy metering system provided by an embodiment of the present application. As shown in FIG. 10, the energy metering system 100 of the present application includes a gas metering apparatus 102 at a user side and a heat value detecting apparatus 103 at a gas source side, which are respectively connected with an energy metering apparatus 101;
the gas metering apparatus 102 is configured to meter a volume consumption of natural gas at the user side;
the heat value detecting apparatus 103 is configured to detect a heat value of a gas source;
the energy metering apparatus 101 can be configured to execute the above energy metering method, receive and store the volume consumption of the natural gas at the user terminal sent by the gas metering apparatus 102, receive the heat value of the gas source sent by the heat value detecting apparatus 103, and perform energy settlement according to settlement time of each terminal meter.

The system may further include a gas source volume collecting apparatus 104 located at the gas source side, which sends a gas source volume to the energy metering apparatus 101.

The above system may further include a heat value collecting apparatus 105 located at an entrance of a billing region, which sends heat value data and a volume consumption of the billing region to the energy metering apparatus 101.

It should be understood that in several embodiments provided by the present application, the disclosed devices and methods can be realized in other ways. For example, the device embodiment described above is only schematic. For example, the division of the modules is only a logical function division. In actual implementations, there may be other division methods, e.g., multiple modules can be combined or integrated into another system, or some features can be ignored or not implemented.

The above-mentioned integrated modules realized in the form of software functional modules can be stored in a computer-readable storage medium. The above software functional module is stored in a storage medium and includes several instructions to make a computer device (which can be a personal computer, a server, a network device, etc.) or a processor perform part of the steps of the method according to various embodiments of the present application.

It should be understood that the processor can be a central processing unit (CPU), other general processors, a digital signal processor (DSP), an application specific integrated circuit (ASIC), etc. The general processor can be a microprocessor or the processor can be any conventional processor, etc. A combination of steps of the method disclosed in the present application can be directly embodied as the completion of execution by a hardware processor, or the completion of execution by a combination of hardware and software modules in the processor.

The memory may include a high-speed RAM (Random Access Memory) memory, and may also include a nonvolatile memory (NVM), such as at least one disk memory, and may also be a U disk, a mobile hard disk, a read-only memory, a magnetic disk or an optical disk.

The above storage medium can be realized by any type of volatile or nonvolatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk. The storage medium can be any available medium that can be accessed by a general-purpose or special-purpose computer.

An exemplary storage medium is coupled to a processor so that the processor can read information from and write information to the storage medium. Of course, the storage medium can also be an integral part of the processor. The processor and the storage medium can be located in an application specific integrated circuit (ASIC). Of course, the processor and the storage medium can also exist as separate components in an electronic device or a main control device.

It should be noted that in the text, the terms “including”, “containing” or any other variation thereof are intended to cover non-exclusive inclusion, so that a process, method, article or apparatus including a series of elements includes not only those elements, but also other elements not explicitly listed, or elements inherent to such process, method, article or apparatus. Without more restrictions, an element defined by the phrase “including one” does not exclude the existence of other identical elements in the process, method, article or apparatus including the element.

The serial numbers of the above embodiments of the present application are only for description and do not represent the advantages and disadvantages of the embodiments.

It can be understood by those skilled in the art that all or part of the steps for implementing the above method embodiments can be completed by hardware related to program instructions. The aforementioned program can be stored in a computer-readable storage medium. When the program is executed, the steps including the above method embodiments are executed; the aforementioned storage medium include an ROM, an RAM, a magnetic disk or an optical disk and other medium that can store program codes.

Finally, it should be explained that the above embodiments are only used to illustrate the technical solutions of the present application, but not to limit it. Although the present application has been described in detail with reference to the foregoing embodiments, it should be understood by those skilled in the art that the technical solutions described in the foregoing embodiments can still be modified, or some or all of its technical features can be replaced by equivalents; however, these modifications or substitutions do not make the essence of the corresponding technical solutions deviate from the scope of the technical solutions of various embodiments of the present application.

1. An energy metering method, comprising:
obtaining a volume consumption of natural gas of a user within a metering period;
determining heat values of various gas sources published in each publishing period within the metering period;
determining a heat value of natural gas used by the user according to a gas source supply structure corresponding to the user and the heat values of various gas sources published in each publishing period, the gas source supply structure being used to indicate a type, a quantity, and a gas supply mode of a gas source of the natural gas used by the user;
determining an energy consumption of natural gas of the user within the metering period according to the volume consumption of natural gas of the user within the metering period and the heat value of the natural gas used by the user.

2. The method according to claim 1, further comprising:
dividing users in a target region into a plurality of billing regions according to a gas source supply structure corresponding to each of the users in the target region, gas source supply structures of each of the billing regions being the same;
wherein the determining the heat value of the natural gas used by the user according to the gas source supply structure corresponding to the user and the heat values of various gas sources published in each publishing period comprises:
for each of the billing regions, determining a heat value of natural gas corresponding to the billing region according to a gas source supply structure corresponding to the billing region and the heat values of various gas sources published in each publishing period;
determining a billing region to which the user belongs according to the gas source supply structure corresponding to the user;
determining the heat value of the natural gas used by the user according to a heat value of natural gas of the billing region to which the user belongs.

3. The method according to claim 2, wherein, for each of the billing regions, the determining the heat value of the natural gas corresponding to the billing region according to the gas source supply structure corresponding to the billing region and the heat values of various gas sources published in each publishing period comprises:
for each of the billing regions, if there is a unique gas source in the billing region directly supplying natural gas to respective users, determining the heat value of the natural gas corresponding to the billing region according to a heat value of the unique gas source published in each publishing period.

4. The method according to claim 2, wherein, for each of the billing regions, the determining the heat value of the natural gas corresponding to the billing region according to the gas source supply structure corresponding to the billing region and the heat values of various gas sources published in each publishing period comprises:
for each of the billing regions, if there are at least two gas sources in the billing region directly and alternately supplying natural gas to respective users, determining the heat value of the natural gas corresponding to the billing region according to respective gas supply time of the at least two gas sources and heat values of the at least two gas sources published in each publishing period.

5. The method according to claim 2, wherein, for each of the billing regions, the determining the heat value of the natural gas corresponding to the billing region according to the gas source supply structure corresponding to the billing region and the heat values of various gas sources published in each publishing period comprises:
for each of the billing regions, if there are at least two gas sources in the billing region, with a part of gas from the at least two gas sources jointly supplying natural gas to respective users and another part of gas from the at least two gas sources separately and individually supplying natural gas to other billing regions, then obtaining a volume consumption of each of the other billing regions supplied by the another part of gas from the at least two gas sources;
determining the heat value of the natural gas corresponding to the billing region according to the volume consumption of each of the other billing regions supplied by the another part of gas from the at least two gas sources and heat values of the at least two gas sources published in each publishing period.

6. The method according to claim 2, wherein, for each of the billing regions, the determining the heat value of the natural gas corresponding to the billing region according to the gas source supply structure corresponding to the billing region and the heat values of various gas sources published in each publishing period comprises:
for each of the billing regions, if there are at least two gas sources in the billing region jointly supplying natural gas to respective users, obtaining a delivery volume of the at least two gas sources within the metering period;
determining the heat value of the natural gas corresponding to the billing region according to the delivery volume of the at least two gas sources within the metering period and heat values of the at least two gas sources published in each publishing period.

7. The method according to claim 2, wherein before determining the heat value of the natural gas corresponding to the billing region, the method further comprises:
determining whether there exists an industrial user in the billing region;
if there exists the industrial user in the billing region, obtaining an energy consumption of natural gas of the industrial user within the metering period;
for each of the billing regions, the determining the heat value of the natural gas corresponding to the billing region according to the gas source supply structure corresponding to the billing region and the heat values of various gas sources published in each publishing period comprises:
for each of the billing regions, if there exists the industrial user in the billing region, determining the heat value of the natural gas corresponding to the billing region according to the energy consumption of the natural gas of the industrial user within the metering period and the heat values of various gas sources published in each publishing period.

8. The method according to claim 7, wherein the obtaining the energy consumption of the natural gas of the industrial user within the metering period comprises:
obtaining a daily average volume consumption and a daily average heat value of the natural gas of the industrial user within the metering period;
determining the energy consumption of the natural gas of the industrial user within the metering period according to the daily average volume consumption and the daily average heat value of the natural gas within the metering period.

9. (canceled)

10. An energy metering device, comprising:
a memory, configured to store program instructions;
a processor, configured to call and execute the program instructions stored in the memory to:
obtain a volume consumption of natural gas of a user within a metering period;
determine heat values of various gas sources published in each publishing period within the metering period;
determine a heat value of natural gas used by the user according to a gas source supply structure corresponding to the user and the heat values of various gas sources published in each publishing period, the gas source supply structure being used to indicate a type, a quantity, and a gas supply mode of a gas source of the natural gas used by the user;
determine an energy consumption of natural gas of the user within the metering period according to the volume consumption of natural gas of the user within the metering period and the heat value of the natural gas used by the user.

11. A non-transitory computer-readable storage medium, wherein the storage medium stores a computer program, when the computer program is executed by a processor, the computer program is enabled to:
obtain a volume consumption of natural gas of a user within a metering period;
determine heat values of various gas sources published in each publishing period within the metering period;
determine a heat value of natural gas used by the user according to a gas source supply structure corresponding to the user and the heat values of various gas sources published in each publishing period, the gas source supply structure being used to indicate a type, a quantity, and a gas supply mode of a gas source of the natural gas used by the user;
determine an energy consumption of natural gas of the user within the metering period according to the volume consumption of natural gas of the user within the metering period and the heat value of the natural gas used by the user.

12. An energy metering system, comprising: a gas metering apparatus at a user side and a heat value detecting apparatus at a gas source side, the gas metering apparatus and the heat value detecting apparatus are respectively connected with an energy metering apparatus;
the gas metering apparatus is configured to meter a volume consumption of natural gas at a user terminal;
the heat value detecting apparatus is configured to detect a heat value of a gas source;
the energy metering apparatus is configured to execute the energy metering method according to claim 1.

13. The method according to claim 3, wherein before determining the heat value of the natural gas corresponding to the billing region, the method further comprises:
determining whether there exists an industrial user in the billing region;
if there exists the industrial user in the billing region, obtaining an energy consumption of natural gas of the industrial user within the metering period;
for each of the billing regions, the determining the heat value of the natural gas corresponding to the billing region according to the gas source supply structure corresponding to the billing region and the heat values of various gas sources published in each publishing period comprises:
for each of the billing regions, if there exists the industrial user in the billing region, determining the heat value of the natural gas corresponding to the billing region according to the energy consumption of the natural gas of the industrial user within the metering period and the heat values of various gas sources published in each publishing period.

14. The method according to claim 4, wherein before determining the heat value of the natural gas corresponding to the billing region, the method further comprises:
determining whether there exists an industrial user in the billing region;
if there exists the industrial user in the billing region, obtaining an energy consumption of natural gas of the industrial user within the metering period;
for each of the billing regions, the determining the heat value of the natural gas corresponding to the billing region according to the gas source supply structure corresponding to the billing region and the heat values of various gas sources published in each publishing period comprises:
for each of the billing regions, if there exists the industrial user in the billing region, determining the heat value of the natural gas corresponding to the billing region according to the energy consumption of the natural gas of the industrial user within the metering period and the heat values of various gas sources published in each publishing period.

15. The method according to claim 5, wherein before determining the heat value of the natural gas corresponding to the billing region, the method further comprises:
determining whether there exists an industrial user in the billing region;
if there exists the industrial user in the billing region, obtaining an energy consumption of natural gas of the industrial user within the metering period;
for each of the billing regions, the determining the heat value of the natural gas corresponding to the billing region according to the gas source supply structure corresponding to the billing region and the heat values of various gas sources published in each publishing period comprises:
for each of the billing regions, if there exists the industrial user in the billing region, determining the heat value of the natural gas corresponding to the billing region according to the energy consumption of the natural gas of the industrial user within the metering period and the heat values of various gas sources published in each publishing period.

16. The method according to claim 6, wherein before determining the heat value of the natural gas corresponding to the billing region, the method further comprises:
determining whether there exists an industrial user in the billing region;
if there exists the industrial user in the billing region, obtaining an energy consumption of natural gas of the industrial user within the metering period;
for each of the billing regions, the determining the heat value of the natural gas corresponding to the billing region according to the gas source supply structure corresponding to the billing region and the heat values of various gas sources published in each publishing period comprises:
for each of the billing regions, if there exists the industrial user in the billing region, determining the heat value of the natural gas corresponding to the billing region according to the energy consumption of the natural gas of the industrial user within the metering period and the heat values of various gas sources published in each publishing period.

17. The method according to claim 13, wherein the obtaining the energy consumption of the natural gas of the industrial user within the metering period comprises:
obtaining a daily average volume consumption and a daily average heat value of the natural gas of the industrial user within the metering;
determining the energy consumption of the natural gas of the industrial user within the metering period according to the daily average volume consumption and the daily average heat value of the natural gas within the metering period.

18. The method according to claim 14, wherein the obtaining the energy consumption of the natural gas of the industrial user within the metering period comprises:
obtaining a daily average volume consumption and a daily average heat value of the natural gas of the industrial user within the metering period;
determining the energy consumption of the natural gas of the industrial user within the metering period according to the daily average volume consumption and the daily average heat value of the natural gas within the metering period.

19. The method according to claim 15, wherein the obtaining the energy consumption of the natural gas of the industrial user within the metering period comprises:
obtaining a daily average volume consumption and a daily average heat value of the natural gas of the industrial user within the metering;
determining the energy consumption of the natural gas of the industrial user within the metering period according to the daily average volume consumption and the daily average heat value of the natural gas within the metering period.

20. The method according to claim 16, wherein the obtaining the energy consumption of the natural gas of the industrial user within the metering period comprises:
obtaining a daily average volume consumption and a daily average heat value of the natural gas of the industrial user within the metering;
determining the energy consumption of the natural gas of the industrial user within the metering period according to the daily average volume consumption and the daily average heat value of the natural gas within the metering period.
